(19) United States
(12) Patent Application Publication
(10) Pub. No.: US 2026/0049191 A1
(43) Pub. Date: Feb. 19, 2026

(54) GRAPHENE ROOFING MEMBRANE

(71) Applicant: Garland Industries, Inc., Independence, OH (US)

(72) Inventors: Julie Anne Geyer, Brecksville, OH (US); Elizabeth C. Massien, Elyria, OH (US); Jason D. Smith, Strongsville, OH (US)

(21) Appl. No.: 19/294,471

(22) Filed: Aug. 8, 2025

Related U.S. Application Data
(60) Provisional application No. 63/682,536, filed on Aug. 13, 2024.

(51) Int. Cl. C08J 5/24; C08J 3/20; C08K 3/04; C08L 95/00; E04D 5/12

(52) U.S. Cl. CPC C08J 5/249; C08J 3/201; C08K 3/042; C08L 95/00; E04D 5/12; C08J 2395/00; C08K 2201/005; C08L 2201/02; C08L 2201/08; C08L 2207/322; C08L 2555/50

(57) ABSTRACT

A roofing membrane includes a layer or bitumen compound, a fabric or mat, and graphene.

### REFERENCED APPLICATION

The present disclosure claims priority on U.S. Application Ser. No. 63/682,536 filed Aug. 13, 2024, which is incorporated herein by reference.

### FIELD OF DISCLOSURE

The present disclosure is directed to an improved roofing membrane system; particularly the present disclosure is directed to a roofing membrane that includes graphene to increase the strength of the roofing membrane; and more particularly the present disclosure is directed to a roofing membrane that includes graphene to increase the strength of the roofing membrane and/or to improve the fire resistance of the roofing membrane.

### BACKGROUND OF THE INVENTION

There is need for a roof membrane that has improved strength.

Prior art patents that are incorporated herein by reference are U.S. Pat. Nos. 2,379,358; 3,255,031; 3,479,201; 3,528,842; 4,039,706; 4,120,132; 4,288,959; 4,342,804; 4,478,869; 5,088,259; 5,132,164; 5,456,785; 5,474,838; 5,540,971; 5,643,399; 5,573,810; 5,695,373; 5,813,176; 5,965,626; 6,110,846; 6,194,519; 6,207,593; 6,296,912; 6,296,921; 6,341,462; 6,360,511; 6,502,360; 7,070,844; 7,803,725; 8,216,681; 8,277,882; 9,441,140; 9,499,986; 9,920,200; 10,011,092; 10,138.375; 10,597,555; 10,626,615; 10,829,938; 11,046,613; 11,136,760; 11,371,244; 11,433,366; 11,427,507; and 11,453,614, and US Patent Publication Nos. 2004/0071938; 2005/0145139; 2005/0250399; 2005/0261407; 2005/0257875; 2005/0261409; 2007/0054129; 2009/0053529 and 2012/0266553.

These references illustrate various types of roof membranes that could be used in accordance with the present disclosure.

### SUMMARY OF DISCLOSURE

The present disclosure is directed to an improved roofing membrane system; particularly the present disclosure is directed to a roofing membrane that includes graphene; more particularly the present disclosure is directed to a bitumen roofing membrane that includes graphene; and still more particularly the present disclosure is directed to a bitumen roofing membrane that includes graphene to increase the strength of the roofing membrane.

In one non-limiting aspect of the present disclosure, the roofing membrane that includes graphene includes 1) a bitumen compound, 2) a fabric or mat, and optionally 3) one or more of a) an optional polymer layer or coating that partially or fully coats one or more outer surface of the fabric or mat and/or bitumen compound layer, b) an optional release liner that is releasably positioned on the bottom surface of the roofing membrane, and/or c) an optional release film that is releasably positioned on the top surface of the fabric or mat, the bitumen compound or the optional polymer layer or coating or otherwise forms a top layer on the roofing membrane, and wherein the graphene can be a) incorporated as a component in the bitumen compound and/or b) form or be included in a separate layer from the fabric or mat and the bitumen compound. In one non-limiting embodiment, at least a portion or all of the graphene is mixed into the bitumen compound prior to the fabric or mat coated with and/or partially or fully impregnated with the bitumen compound. The graphene can be mixed into the bitumen compound by a) adding particles of graphene to the bitumen compound while the bitumen compound is in liquid form, b) adding a solution of process oil and particles of graphene to the bitumen compound while the bitumen compound is in liquid form, and/or c) adding an extruded material to the bitumen compound while the bitumen compound is in liquid form, and wherein the extruded material is a polymer-graphene extrusion. In another non-limiting embodiment, one or more graphene layers are applied on a top and/or a bottom surface of the fabric or mat and/or the layer of bitumen compound. The graphene layer can be formed of a) pure graphene, b) polymer material that includes particles of graphene, and/or c) an extruded layer that includes polymer and graphene. In another non-limiting embodiment, the graphene is mixed into the bitumen compound prior to the fabric or mat be coated with and/or partially or fully impregnated with the bitumen compound, and furthermore one or more graphene layers is applied on a top and/or a bottom surface of the fabric or mat and/or the layer of bitumen compound. In another non-limiting embodiment, the roofing membrane can be optionally a flexible and/or rollable roofing membrane. In another non-limiting embodiment, the thickness of the roofing membrane is generally at least 3 mils (e.g., 3-1000 mils and all values and ranges therebetween).

### The Layer Formed of Bitumen Compound

The layer of bitumen compound includes a primary hydrocarbon compound (e.g., asphalt, bitumen, modified bitumen, coal-tar, coal-based alternatives (COPHALT), modified coal-tar, biosourced lignin-based asphalt alternatives, asphalt/lignin-based blends, etc.); and optionally one or more of a) filler (e.g., calcium carbonate, limestone, chalk, clay, sand, dolomite, kaolin, silica, talc, etc.); b) polymer modifier (e.g., APAO [Amorphous Polyolefin], APP [Atactic Polypropylene], EVA [Ethylene Vinyl Acetate], EBA [Ethylene Butyl Acrylate], PPA [Polyphthalamide], PPI [Polymeric Polyisocyanate], PE [Polyethylenc], PP [Polypropylene] SEBS [Styrene Ethylene Butadiene Styrene], SBS [Styrene Butadiene Styrene], SIS [Styrene-Isoprene-Styrene], polyurethane resins, polyurethane prepolymers, thermoplastic urethane [TPU], etc.); c) hydrocarbon resin or process oil (e.g., naphthenic oil, paraffinic oil, C5-C9 aromatic hydrocarbon, etc.); d) tackifying agent; e) antioxidant; f) UV stabilizer; g) cross-linkers; h) adhesion enhancer; i) fire retardant (e.g., alumina trihydrate, ammonium polyphosphate, magnesium hydroxide, zinc borate, melamine polyphosphate, and antimony oxide (Sb₂O₃), etc.); j) wax (e.g., paraffin wax, polypropylene wax, etc.); k) reinforcement fibers (e.g., Kevlar®, carbon fibers, fiberglass, boron fibers, polyethylene fibers, polypropylene fibers, recycled polymer and/or plastic fibers, etc.); 1) charring agent; and/or n) graphene.

In one non-limiting embodiment, the primary hydrocarbon compound constitutes 0.1-90 wt. % (and all values and ranges therebetween) of the bitumen compound. In one specific formulation, the primary hydrocarbon compound constitutes 25-80 wt. % of the bitumen compound. In another specific formulation, the primary hydrocarbon compound constitutes 25-70 wt. % of the bitumen compound. In another specific formulation, the primary hydrocarbon compound constitutes 30-60 wt. % of the bitumen compound. In another specific formulation, the primary hydrocarbon compound constitutes 35-55 wt. % of the bitumen compound layer. The primary hydrocarbon compound can be fully formed of asphalt, bitumen, modified bitumen, coal-tar, coal-based alternatives (COPHALT), modified coal-tar, tar, pitch, bio-sourced lignin-based asphalt alternatives, or asphalt/lignin-based blends, or can be some blend of asphalt, bitumen, modified bitumen, coal-tar, tar, pitch, coal-based alternatives (COPHALT), modified coal-tar, bio-sourced lignin-based asphalt alternatives, and asphalt/lignin-based blends. In one non-limiting formulation, the bitumen compound is fully or partially formed of asphalt or bitumen (e.g., PG64-22 grade, etc.). In another non-limiting formulation, the primary hydrocarbon compound is bitumen penetration grade 40/50. In another non-limiting formulation, the primary hydrocarbon compound is bitumen penetration grade 50/70. In another non-limiting formulation, the primary hydrocarbon compound is bitumen penetration grade 60/70. In another non-limiting formulation, the primary hydrocarbon compound has a softening point about 43.3-121.1° C. (110-250° F.) (and all values and ranges therebetween); and a penetration typically of about 4-80 dmm (and all values and ranges therebetween) at 22.2° C. (75° F.). In one non-limiting embodiment, the primary hydrocarbon compound includes 25-100 wt. % bitumen (and all values and ranges therebetween) and 0-75 wt. % coal tar (and all values and ranges therebetween). In another non-limiting embodiment, the primary hydrocarbon compound includes 60-100 wt. % bitumen and 0-40 wt. % coal tar (and all values and ranges therebetween).

The filler, when included in the bitumen compound, constitutes about 0.5-70 wt. % (and all values and ranges therebetween) of the bitumen compound. In one non-limiting formulation, the filler (when used) constitutes 0.5-60 wt. % of the bitumen compound. In another non-limiting formulation, the filler (when used) constitutes 10-60 wt. % of the bitumen compound. In another non-limiting formulation, the filler (when used) constitutes 15-50 wt. % of the bitumen compound. In another non-limiting formulation, the filler (when used) constitutes 15-40 wt. % of the bitumen compound. In another non-limiting formulation, the filler (when used) constitutes 15-35 wt. % of the bitumen compound. In another non-limiting formulation, the weight percent of filler in the bitumen compound (when used) is less than the weight percent of the primary hydrocarbon compound in the bitumen compound. The filler can include one or more of calcium carbonate (e.g., oyster shells and other shells of marine organisms, snail shells, coal balls, pearls, eggshells, chalk, limestone, etc.), clay (e.g., recycled tile, recycled clay plates, recycled porcelain, recycled dishes, recycled pots, etc.), dolomite, kaolin (e.g., recycled porcelain, recycled china, feldspar, etc.), silica, talc, sand, chalk, inorganic fillers or mineral stabilizers, organic materials such as ground tire rubber, slate flour, etc.; however, other or additional fillers can be used. In one non-limiting formulation, the filler (when used) includes calcium carbonate, limestone, silica and/or talc. In another non-limiting formulation, the filler, when used, includes calcium carbonate and/or limestone.

The polymer modifier, when included in the bitumen compound, constitutes about 0.05-50 wt. % (and all values and ranges therebetween) of the bitumen compound. In one non-limiting formulation, the polymer modifier (when used) constitutes 0.05-30 wt. % of the bitumen compound. In another non-limiting formulation, the polymer modifier (when used) constitutes 2-22 wt. % of the bitumen compound. In another non-limiting formulation, the polymer modifier (when used) constitutes 5-20 wt. % of the bitumen compound. In another non-limiting formulation, the polymer modifier (when used) constitutes 6-15 wt. % of the bitumen compound. In another non-limiting formulation, the weight percent of polymer modifier in the bitumen compound, when used, is less than the weight percent of the primary hydrocarbon compound in the bitumen compound. The polymer modifier can include one or more of APAO (Amorphous Polyolefin), APP (Atactic Polypropylene), EVA (Ethylene Vinyl Acetate), EBA (Ethylene Butyl Acrylate), PPA (Polyphthalamide), PPI (Polymeric Polyisocyanate), PE (Polyethylene), PP (Polypropylene), SEBS (Styrene Ethylene Butadiene Styrene), SBS (Styrene Butadiene Styrene), SIS (Styrene-Isoprene-Styrene), SBR (styrene-butadiene-rubber), polyurethane resins, polyurethane prepolymers, thermoplastic urethane (TPU), etc.; however, other or additional polymer modifier can be used. In one non-limiting formulation, the polymer modifier includes SBS and/or polyurethane. In another non-limiting formulation, the polymer modifier includes or is SBS.

The process oil or hydrocarbon resin, when included in the bitumen compound, is about 0.05-30 wt. % (and all values and ranges therebetween) of the bitumen compound. In one non-limiting formulation, the process oil or hydrocarbon resin (when used) constitutes 0.05-20 wt. % of the bitumen compound. In another non-limiting formulation, the process oil or hydrocarbon resin (when used) constitutes 1-10 wt. % of the bitumen compound. In another non-limiting formulation, the process oil or hydrocarbon resin (when used) constitutes 1-5 wt. % of the bitumen compound. In another non-limiting formulation, the weight percent of process oil or hydrocarbon resin in the bitumen compound (when used) is less than the weight percent of the primary hydrocarbon compound in the bitumen compound. The hydrocarbon resin or process oil can include one or more of naphthenic oil, paraffinic oil, C5-C9 aromatic hydrocarbon, etc. In one non-limiting formulation, the hydrocarbon resin or process oil includes naphthenic oil and/or paraffinic oil; however, other or additional hydrocarbon resin or process oil can be used.

The antioxidant, when included in the bitumen compound, is about 0.05-30 wt. % (and all values and ranges therebetween) of the bitumen compound. In one non-limiting formulation, the antioxidant (when used) constitutes 0.05-5 wt. % of the bitumen compound. In another non-limiting formulation, the antioxidant (when used) constitutes 0.05-1 wt. % of the bitumen compound. In another non-limiting formulation, the weight percent of antioxidant in the bitumen compound (when used) is less than the weight percent of the primary hydrocarbon compound in the bitumen compound. The antioxidant can include one or more of aromatic amines, hindered phenolics, phosphites, ethylene bis [3,3-bis(3-tert-butyl-4-hydroxyphenyl) butyrate], sulfur-containing compounds (e.g., thioethers, thioesters, etc.); however, other or additional antioxidant can be used.

The UV stabilizer, when included in the bitumen compound, is about 0.05-20 wt. % (and all values and ranges therebetween) of the bitumen compound. In one non-limiting formulation, the UV stabilizer, when used, constitutes 0.05-5 wt. % of the bitumen compound. In another non-limiting formulation, the UV stabilizer (when used) constitutes 0.05-1 wt. % of the bitumen compound. In another non-limiting formulation, the weight percent of UV stabilizer in the bitumen compound (when used) is less than the weight percent of the primary hydrocarbon compound in the bitumen compound. The UV stabilizer can include one or more of benzotriazole UV absorber, hindered amine radical scavenge (e.g., Benzotriazole UV Absorber, Light Stabilizer 770 [Bis (2,2,6,6-tetramethyl-4-piperidine) sebacate], etc.), hindered amine light stabilizer (HALS) (e.g., derivatives of tetramethylpiperidine, etc.), layered double hydroxide (LDH), carbon black, etc.; however, other or additional UV stabilizers can be used.

The one or more cross-linkers, when included in the bitumen compound, are about 0.05-30 wt. % (and all values and ranges therebetween) of the bitumen compound. In one non-limiting formulation, the cross-linkers (when used) constitute 0.05-10 wt. % of the bitumen compound. In another non-limiting formulation, the cross-linkers (when used) constitute 0.05-5 wt. % of the bitumen compound. In another non-limiting formulation, the weight percent of cross-linkers in the bitumen compound (when used) is less than the weight percent of the primary hydrocarbon compound in the bitumen compound. The cross-linkers can include one or more of sulfur, sulfur compounds, bismaleimides, polymerizable monofunctional vinyl aromatic monomer (e.g., styrene, etc.), polyfunctional polymerizable vinyl aromatic monomer (e.g., divinylbenzene etc.), etc.; however, other or additional cross-linkers can be used.

The adhesion enhancer, when included in the bitumen compound, is about 0.05-30 wt. % (and all values and ranges therebetween) of the bitumen compound. In one non-limiting formulation, the adhesion enhancer (when used) constitutes 0.05-5 wt. % of the bitumen compound. In another non-limiting formulation, the adhesion enhancer (when used) constitutes 0.05-2 wt. % of the bitumen compound. In another non-limiting formulation, the weight percent of adhesion enhancer in the bitumen compound (when used) is less than the weight percent of the primary hydrocarbon compound in the bitumen compound. The adhesion enhancer can include one or more of amine adhesion promoters, naphthenates, organosilanes-based adhesion promoters, etc.; however, other or additional adhesion enhancer can be used.

The fire retardant, when included in the bitumen compound, is about 0.05-50 wt. % (and all values and ranges therebetween) of the bitumen compound. In one non-limiting formulation, the fire retardant (when used) constitutes 1-45 wt. % of the bitumen compound. In another non-limiting formulation, the fire retardant (when used) constitutes 2-40 wt. % of the bitumen compound. In another non-limiting formulation, the fire retardant (when used) constitutes 5-35 wt. % of the bitumen compound. In another non-limiting formulation, the weight percent of fire retardant in the bitumen compound layer (when used) is less than the weight percent of the primary hydrocarbon compound in the bitumen compound layer. The fire retardant can include one or more of alumina trihydrate, ammonium polyphosphate, magnesium hydroxide, melamine, zinc borate, melamine polyphosphate, and antimony oxide (Sb₂O₃), etc.; however, other or additional fire retardant can be used. In another non-limiting embodiment, the fire retardant can include alumina trihydrate and ammonium polyphosphate. In another non-limiting embodiment, the fire retardant can include alumina trihydrate and ammonium polyphosphate, and the weight ratio of alumina trihydrate to ammonium polyphosphate is 1.1:1 to 45:1 (and all values and ranges therebetween).

The tackifying agent, when included in the bitumen compound, is about 0.05-30 wt. % (and all values and ranges therebetween) of the bitumen compound. In one non-limiting formulation, the tackifying agent (when used) constitutes 0.05-5 wt. % of the bitumen compound. In another non-limiting formulation, the tackifying agent (when used) constitutes 0.05-2 wt. % of the bitumen compound. In another non-limiting formulation, the weight percent of tackifying agent in the bitumen compound (when used) is less than the weight percent of the primary hydrocarbon compound in the bitumen compound. The tackifying agent can include one or more of inorganic salt electrolytes and organic tackifiers, etc.; however, other or additional tackifying agent can be used.

The softening agent, when included in the bitumen compound, is about 0.05-30 wt. % (and all values and ranges therebetween) of the bitumen compound. In one non-limiting formulation, the softening (when used) constitutes 0.05-5 wt. % of the bitumen compound. In another non-limiting formulation, the softening agent (when used) constitutes 0.05-2 wt. % of the bitumen compound. In another non-limiting formulation, the weight percent of softening agent in the bitumen compound (when used) is less than the weight percent of the primary hydrocarbon compound in the bitumen compound layer.

The wax, when included in the bitumen compound, is about 0.05-15 wt. % (and all values and ranges therebetween) of the bitumen compound. In one non-limiting formulation, the wax (when used) constitutes 0.05-5 wt. % of the bitumen compound. In another non-limiting formulation, the wax (when used) constitutes 0.05-1 wt. % of the bitumen compound. In another non-limiting formulation, the weight percent of wax in the bitumen compound (when used) is less than the weight percent of the primary hydrocarbon compound in the bitumen compound. The wax can include paraffin wax, polypropylene wax, Fischer-Tropsic wax, ester wax, amide wax, THP wax, microcrystalline wax, etc.; however, other or additional wax can be used. The reinforcement fibers, when included in the bitumen compound, are about 0.05-40 wt. % (and all values and ranges therebetween) of the bitumen compound. In one non-limiting formulation, the reinforcement fibers (when used) constitute 0.05-30 wt. % of the bitumen compound. In another non-limiting formulation, the reinforcement fibers (when used) constitute 0.05-25 wt. % of the bitumen compound. In another non-limiting formulation, the reinforcement fibers (when used) constitute 0.05-10 wt. % of the bitumen compound. In another non-limiting formulation, the weight percent of reinforcement fibers in the bitumen compound (when used) is less than the weight percent of the primary hydrocarbon compound in the bitumen compound. The reinforcement fibers can include one or more of aramid fibers (e.g., poly-para-phenylene terephthalamide [Kevlar®]), carbon fibers, fiberglass, boron fibers, polyethylene fibers, polypropylene fibers, recycled polymer, and/or plastic fibers; however, other or additional reinforcement fibers can be used.

The graphene, when included in the bitumen compound, is about 0.01-30 wt. % (and all values and ranges therebetween) of the bitumen compound. In one non-limiting formulation, the graphene (when used) constitutes 0.01-15 wt. % of the bitumen compound. In another non-limiting formulation, the graphene (when used) constitutes 0.02-10 wt. % of the bitumen compound. In another non-limiting formulation, the graphene (when used) constitutes 0.02-5 wt. % of the bitumen compound. In another non-limiting formulation, the weight percent of graphene in the bitumen compound (when used) is less than the weight percent of the primary hydrocarbon compound in the bitumen compound. The particle size of the graphene is about 0.1-100 microns and all values and ranges therebetween. In one non-limiting embodiment, the particle size of the graphene is about 0.5-20 microns. In another non-limiting embodiment, the particle size of the graphene is about 1-10 microns. The graphene can be added to the bitumen compound in powdered form, granule form, dispersed in a liquid (e.g., process oil, etc.), and/or in an extruded form (e.g., graphene extruded with a polymer and formed into graphene-polymer pellets, etc.). When the graphene is added to the bitumen compound in pellet form (e.g., extruded polymer-graphene pellet, etc.), the weight ratio of the polymer material to the graphene in the bitumen compound is 99.99:1 to 1:99.99 (and all values and ranges there between). In one non-limiting pellet formulation, the weight ratio of the polymer material to the graphene in the bitumen compound is 99:1 to 51:1. The polymer used to form of the pellet can be or include one or more of APAO (Amorphous Polyolefin), APP (Atactic Polypropylene), EVA (Ethylene Vinyl Acetate), EBA (Ethylene Butyl Acrylate), PPA (Polyphthalamide), PPI (Polymeric Polyisocyanate), PE (Polyethylene), PP (Polypropylene), SEBS (Styrene Ethylene Butadiene Styrene), SBS (Styrene Butadiene Styrene), SIS (Styrene-Isoprene-Styrene), SBR (styrene-butadiene-rubber), polyurethane resins, polyurethane prepolymers, thermoplastic urethane (TPU), etc. In one non-limiting formulation, the weight percent of the pellet additional to the bitumen compound is 0.1-35 wt. % (and all values and ranges therebetween), and wherein the weight ratio of the polymer material to the graphene in the graphene pellet is 99:1 to 51:1. In one non-limiting formulation, the weight percent of the pellet additional to the bitumen compound is 0.5-10 wt. % (and all values and ranges therebetween), and wherein the weight ratio of the polymer material to the graphene in the graphene pellet is 99:1 to 51:1. It was found that the graphene does not shear easily when added and mixed in with the component of the bitumen compound. It was found that by coextruding the graphene with a polymer (e.g., SBS, etc.) upstream of mixing of the components of the bitumen compound, the processing of the bitumen compound did not require the use of specialized shearing and mixing equipment to have the graphene successfully blended into and dispersed in the bitumen compound.

The charring agent, when included in the bitumen compound, is about 0.01-30 wt. % (and all values and ranges therebetween) of the bitumen compound. In one non-limiting formulation, the charring agent (when used) constitutes 0.01-15 wt. % of the bitumen compound. In another non-limiting formulation, the charring agent (when used) constitutes 0.02-10 wt. % of the bitumen compound. In another non-limiting formulation, the charring agent (when used) constitutes 0.02-5 wt. % of the bitumen compound. In another non-limiting formulation, the weight percent of charring agent in the bitumen compound (when used) is less than the weight percent of the primary hydrocarbon compound in the bitumen compound. The charring agent can include one or more of melamine compounds (e.g., melamine poly (zinc phosphate), etc.), poly (piperazinyl oxalamide) (PPOA), pentaerythritol (PER), chitosan (CTS), lignin (LI), etc.; however, other or additional charring agents can be used.

In one non-limiting embodiment, the weight percent of the primary hydrocarbon compound in the bitumen compound is greater than or equal to the combined weight percent of filler, polymer modifier, hydrocarbon resin or process oil, tackifying agent, antioxidant, UV stabilizer, cross-linkers, adhesion enhancer, fire retardant, softening agent, wax, reinforcement fibers, graphene and charring agent in the bitumen compound.

In another non-limiting embodiment, the weight percent of the primary hydrocarbon compound in the bitumen compound is greater than the combined weight percent of polymer modifier, hydrocarbon resin or process oil, tackifying agent, antioxidant, UV stabilizer, cross-linkers, adhesion enhancer, fire retardant, softening agent, wax, reinforcement fibers, graphene and charring agent in the bitumen compound.

In another non-limiting embodiment, the weight percent of the primary hydrocarbon compound in the bitumen compound is greater than the combined weight percent of polymer modifier, hydrocarbon resin or process oil, tackifying agent, antioxidant, UV stabilizer, cross-linkers, adhesion enhancer, fire retardant, softening agent, wax, graphene and charring agent in the bitumen compound.

In another non-limiting embodiment, the layer of bitumen compound can optionally include one or more internal reinforcement layers. The one or more internal reinforcement layers are different from a fiber reinforcement mat in that the one or more internal reinforcement layers are individual strands, strings, rovings, films, etc. that are not connected together. The one or more internal reinforcement layers can partially or fully extend the width and/or length of the layer of bitumen compound. Generally, when an internal reinforcement layer exists in the layer of bitumen compound, only a single internal reinforcement layer is included in the layer of bitumen compound. The internal reinforcement layer can be formed of one or more of fiberglass, nylon, polyester, cotton, silk, wool, hemp, straw, bamboo, flax, jute, modal, asbestos fibers, basalt fibers, aramid fiber, acrylic fiber, polyurethane fiber, olefin fiber, rayon fiber, polylactide fiber, lurex fiber, carbon fibers, boron fibers, polyethylene fibers, aromatic polyamide or aramid fibers (e.g., Kevlar™, Twaron™, etc., and any blend of these materials. When an internal reinforcement layer is used, the internal reinforcement is partially or fully saturated/encapsulated with the bitumen compound. The internal reinforcement layer (when used) provides reinforcement and internal strength to the layer of bitumen compound. The internal reinforcement layer (when used) is generally formed of a flexible material that enables the roofing membrane that includes the layer of bitumen compound to be rolled into a roll without causing damage to the layer of bitumen compound; however, this is not required. In one non-limiting configuration, the roofing membrane can be rolled into a roll having a diameter of 8 inches or less without damaging the roofing membrane. Generally, the internal reinforcement layer is located at or near the middle of the layer of bitumen compound; however, this is not required. Generally, the internal reinforcement layer, when used, extends 80-100% (and all values and ranges therebetween) of the width of the layer of bitumen compound, and 80-100% (and all values and ranges therebetween) of the length of the layer of the bitumen compound. In another non-limiting embodiment, the thickness of the internal reinforcement layer is generally 2-150 mil (0.002-0.15 in. and all values and ranges therebetween). In one non-limiting arrangement, the thickness of the internal reinforcement layer is generally 2-50 mil.

In another non-limiting arrangement, the thickness of the layer of bitumen compound is generally 2-600 mil (0.002-0.6 in. and all values and ranges therebetween). In another non-limiting arrangement, the thickness of the layer of bitumen compound is generally 5-250 mil. In another non-limiting arrangement, the thickness of the layer of bitumen compound is generally 10-150 mil. In another non-limiting arrangement, the thickness of the layer of bitumen compound is generally 40-130 mil. In another non-limiting arrangement, the thickness of the layer of bitumen compound is generally 80-100 mil.

In another non-limiting embodiment, the bitumen compound layer forms a waterproofing layer in the bitumen roofing membrane.

Non-limiting examples of the composition of the bitumen compound layer (absent any optional internal reinforcement layer) are as follows:

### Example 1

Primary hydrocarbon compound 0.1-90 wt. %
Filler 0-70 wt. %
Polymer Modifier 0-50 wt. %
Hydrocarbon Resin Process Oil 0-30 wt. %
Antioxidant 0-30 wt. %
UV Stabilizer 0-20 wt. %
Cross-Linker 0-30 wt. %
Adhesion Enhancer 0-30 wt. %
Fire Retardant 0-50 wt. %
Tackifying Agent 0-30 wt. %
Wax 0-15 wt. %
Internal Reinforcement Fiber 0-40 wt. %
Graphene 0-30 wt. %
Charring Agent 0-30 wt. %.

### Example 2

Primary hydrocarbon compound 2-90 wt. %
Filler (e.g., calcium carbonate, silica, talc, etc.) 0.5-70 wt. %
Polymer Modifier (e.g., SBS, Polyurethane, etc.) 0.05-50 wt. %
Hydrocarbon Resin Process Oil (e.g., naphthenic 0-30 wt. % oil, paraffinic oil, etc.)
Antioxidant 0-30 wt. %
UV Stabilizer 0-20 wt. %
Cross-Linker 0-30 wt. %
Adhesion Enhancer 0-30 wt. %
Fire Retardant 0-30 wt. %
Tackifying Agent 0-30 wt. %
Wax 0-15 wt. %
Internal Reinforcement Fiber (e.g., fiber, etc.) 0-40 wt. %
Graphene 0.01-20 wt. %
Charring Agent 0-20 wt. %.

### Example 3

Primary hydrocarbon compound 25-80 wt. %
Filler (e.g., calcium carbonate, silica, talc, etc.) 0.5-60 wt. %
Polymer Modifier (e.g., SBS, Polyurethane, etc.) 0.05-30 wt. %
Hydrocarbon Resin Process Oil (e.g., naphthenic 0-20 wt. % oil, paraffinic oil, etc.)
Antioxidant 0-5 wt. %
UV Stabilizer 0-5 wt. %
Cross-Linker 0-10 wt. %
Adhesion Enhancer 0-5 wt. %
Fire Retardant 0-25 wt. %
Tackifying Agent 0-5 wt. %
Wax 0-5 wt. %
Internal Reinforcement Fiber (e.g., fiber, etc.) 0-30 wt. %
Graphene 0.01-15 wt. %
Charring Agent 0-15 wt. %.

### Example 4

Primary hydrocarbon compound 25-70 wt. %
Filler (e.g., calcium carbonate, silica, talc, etc.) 5-60 wt. %
Polymer Modifier (e.g., SBS, Polyurethane, etc.) 2-22 wt. %
Hydrocarbon Resin Process Oil (e.g., naphthenic 0-10 wt. % oil, paraffinic oil, etc.)
Antioxidant 0-1 wt. %
UV Stabilizer 0-1 wt. %
Cross-Linker 0-5 wt. %
Adhesion Enhancer 0-2 wt. %
Fire Retardant 0-20 wt. %
Tackifying Agent 0-2 wt. %
Wax 0-2 wt. %
Internal Reinforcement Fiber (e.g., fiber, etc.) 0-25 wt. %
Graphene 0.02-10 wt. %
Charring Agent 0-10 wt. %.

### Example 5

Primary hydrocarbon compound 30-60 wt. %
Filler (e.g., calcium carbonate, silica, talc, etc.) 5-40 wt. %
Polymer Modifier (e.g., SBS, Polyurethane, etc.) 5-20 wt. %
Hydrocarbon Resin Process Oil (e.g., naphthenic 0.2-5 wt. % oil, paraffinic oil, etc.)
Antioxidant 0.05-1 wt. %
UV Stabilizer 0.05-1 wt. %
Cross-Linker 0-5 wt. %
Adhesion Enhancer 0-2 wt. %
Fire Retardant 0.5-15 wt. %
Tackifying Agent 0-2 wt. %
Wax 0.1-2 wt. %
Internal Reinforcement Fiber (e.g., fiber, etc.) 0-20 wt. %
Graphene 0.02-6 wt. %
Charring Agent 0.05-6 wt. %.

### Example 6

Primary hydrocarbon compound 35-55 wt. %
Filler (e.g., calcium carbonate, silica, talc, etc.) 15-35 wt. %
Polymer Modifier (e.g., SBS, Polyurethane, etc.) 6-15 wt. %
Hydrocarbon Resin Process Oil (e.g., naphthenic 0.4-5 wt. % oil, paraffinic oil, etc.)
Antioxidant 0.05-1 wt. %
UV Stabilizer 0.05-1 wt. %
Cross-Linker 0-5 wt. %
Adhesion Enhancer 0-2 wt. %
Fire Retardant 1-15 wt. %
Tackifying Agent 0-2 wt. %
Wax 0.1-1.5 wt. %
Internal Reinforcement Fiber (e.g., fiber, etc.) 0-15 wt. %
Graphene 0.02-5 wt. %
Charring Agent 0.05-5 wt. %.

### Example 7

Primary hydrocarbon compound 40-55 wt. %
Filler (e.g., calcium carbonate, silica, talc, etc.) 15-30 wt. %
Polymer Modifier (e.g., SBS, Polyurethane, etc.) 8-15 wt. %
Hydrocarbon Resin Process Oil (e.g., naphthenic 0.6-4 wt. % oil, paraffinic oil, etc.)
Antioxidant 0.05-1 wt. %
UV Stabilizer 0.05-1 wt. %
Cross-Linker 0-4 wt. %
Adhesion Enhancer 0-1 wt. %
Fire Retardant 5-15 wt. %
Tackifying Agent 0-1 wt. %
Wax 0.2-1.2 wt. %
Internal Reinforcement Fiber (e.g., fiber, etc.) 0-10 wt. %
Graphene 0.02-4 wt. %
Charring Agent 0.05-4 wt. %.

For Examples 1-7, it will be appreciated that all of the above ranges include any value between the range and any other range that is between the ranges set forth above. Any of the above values that include the range from 0 to the stated value also includes and all values and ranges therebetween.

### The Fabric or Mat

The fabric or mat is used as a reinforcement layer for the bitumen roofing membrane. The fabric or mat can be a) applied on the top surface of the layer of bitumen compound, b) applied on the bottom surface of the layer of bitumen compound, or c) partially or fully encapsulated/saturated in the layer of bitumen compound. The fabric or mat can be partially or fully saturated with the bitumen compound. As can be appreciated, multiple fabric or mat can be used such that one fabric or mat is a) applied on the top surface of the layer of bitumen compound, b) applied on the bottom surface of the layer of bitumen compound, or c) partially or fully encapsulated/saturated in the layer of bitumen compound, and another fabric or mat is a) applied on the top surface of the layer of bitumen compound, b) applied on the bottom surface of the layer of bitumen compound, or c) partially or fully encapsulated/saturated in the layer of bitumen compound.

When the layer of bitumen compound includes the optional internal reinforcement layer, the fabric or mat and the optional internal reinforcement layer are generally spaced from one another. When the layer of bitumen compound includes the optional internal reinforcement layer, the fabric or mat generally has a greater thickness than the thickness of the optional internal reinforcement layer; however, this is not required. The composition of the fabric or mat and the optional internal reinforcement layer can be the same or different. One non-limiting purpose of the fabric or mat is to function as a reinforcement layer for the roofing membrane. Another non-limiting optional purpose of the fabric or mat is to strengthen the roofing membrane.

The fabric or mat generally has a thickness that is thinner than the thickness of the layer of bitumen compound; however, this is not required. Generally, the thickness ratio of the roofing membrane to the thickness of the fabric or mat is at least about 1.1:1 (e.g., 1.1:1 to 200:1 and all values and ranges therebetween), typically at least about 1.5:1, and more typically about 2:1 to 100:1; however, other thickness ratios can be used.

In another non-limiting embodiment, when the fiber reinforcement layer is impregnated in the layer of bitumen compound, the fabric or mat can optionally be located at or near the mid-thickness of the layer of bitumen compound; however, this is not required.

In another non-limiting embodiment, the fabric or mat provides reinforcement and internal strength to the roofing membrane.

In another non-limiting embodiment, when the roofing membrane includes two or more fabrics or mats, the fabric or mats are generally spaced from one another; however, this is not required.

In another non-limiting embodiment, when the roofing membrane includes two or more fabrics or mats, the thickness of each of the fabrics or mats can be the same or different.

In another non-limiting embodiment, the fabric or mat can optionally have fire-retardant properties. In non-limiting configuration, the fibers and/or the fabric or mat can optionally be pre-treated and/or post-treated with one or more fire-retardant materials (e.g., halogenated compound-containing coatings, etc.).

In another non-limiting embodiment, the fabric or mat can be secured to the layer of bitumen compound by a variety of arrangements (e.g., being partial or fully impregnated in the layer of bitumen compound, adhesively connected to the layer of bitumen compound, melted connection with the layer of bitumen compound, stitching, staples, rivets, clamp, etc.).

The fabric or mat generally covers or spans 50-100% (and all values and ranges therebetween) of the width of the roofing membrane, and also generally covers or spans 50-100% (and all values and ranges therebetween) of the longitudinal length of the roofing membrane. In one non-limiting embodiment, the fabric or mat generally covers or spans 75-100% of the width of the roofing membrane, and also generally covers or spans 75-100% of the longitudinal length of the roofing membrane. In one non-limiting specific configuration, the fabric or mat generally covers or spans 95-100% of the width of the roofing membrane, and also generally covers or spans 95-100% of the longitudinal length of the roofing membrane. In another non-limiting specific configuration, the fabric or mat generally covers or spans 75-90% of the width of the roofing membrane, and/or generally covers or spans 75-90% of the longitudinal length of the roofing membrane. The region of the roofing membrane that is absent the fabric or mat can form a lap line region. The width of the lap line region (when used) is generally 0.5-6 in. (and all values and ranges therebetween), typically the width of the lap line region is 1-5 in., and more typically, the width of the lap line region is 3-4 in. In another non-limiting embodiment, the fabric or mat can be made wide enough to span 50-100% of the longitudinal length of the roofing membrane and overhang one edge of the roofing membrane to form a ready-made lap that ties into the adjacent membrane. This overhanging edge can have a length or width of 0.5-10 in. (and all values and ranges therebetween). When the fabric or mat generally covers or spans 75-90% of the width of the roofing membrane, the region of the roofing membrane that is absent the fabric or mat (e.g., lap line region) can optionally include a release material (e.g., polymeric liner, paper liner, etc.). Such release material can be of similar composition and thickness as the optional release liner that can be included in the bottom surface of the roofing membrane as discussed below; however, this is not required.

The fabric or mat may be a woven mat, a non-woven mat, a mat formed by non-overlapping fibers (e.g., rovings, etc.), or a mat formed by overlapping fibers. In one non-limiting embodiment, the fabric or mat is a woven mat. In one non-limiting configuration, the material used to at least partially form the fabric or mat is partially or fully formed of fibers that are at least 0.2 in. in length (e.g., 0.2-100+ in. and all values and ranges therebetween) and are partially or fully held together by a binder (e.g., polymeric binder, adhesive, etc.), stitching, melted bond, and/or weaving. In one non-limiting arrangement, the fabric or mat is formed of a plurality of fibers that are oriented in multiple directions from one another (e.g., multi-directional fabric or mat) and such fibers are bonded together by a polymeric binder material (e.g., acrylic binder, etc.), stitched together, woven together, and/or otherwise connected together.

The fabric or mat is generally flexible and/or rollable. In one non-limiting configuration, the fabric or mat can be rolled into a roll have a diameter of 8 inches or less without damaging the fabric or mat.

The fabric or mat generally has an average thickness of at least 2 mil (0.002 in.) and typically has an average thickness than is up to 160 mil (0.16 in.) (and all values and ranges therebetween). In one non-limiting configuration, the fabric or mat has an average thickness of 2-60 mil. In another non-limiting configuration, the fabric or mat has an average thickness of 2-40 mil. In another non-limiting configuration, the fabric or mat has an average thickness of 10-20 mil.

The fabric or mat is formed from one or more materials (e.g., fiberglass, nylon, polyester, polycrystalline fibers, cotton, cellulose, silk, wool, hemp, straw, bamboo, flax, ramic, hemp, sisal, wool, linen (flax), jute, modal, asbestos fibers, basalt fibers, aramid fiber, acrylic fiber, polyurethane fiber, olefin fiber, rayon fiber, polylactide fiber, lurex fiber, carbon fibers, boron fibers, polyethylene fibers, polyolefin fibers, polyurethane fibers, vinyl polymer fibers, polyamide fibers, aromatic polyamide or aramid fibers (e.g., Kevlar™, Twaron™, etc.), polyethylene fibers, polypropylene fibers, thermoplastic fiber filaments (e.g., polyamide fibers of poly (p-phenylene terephthalate), poly (o-phenylene terephthalamide), ultra-low shrink polyester), recycled polymer fibers, recycled, plastic fibers, and any blend of these materials). The fibers in the fabric or mat can be continuous filaments, fibers, strands and/or yarn; however, this is not required). In one non-limiting embodiment, the fabric or mat is formed of or includes polyester and/or fiberglass fibers.

The fabric or mat can optionally have fire-retardant properties. In non-limiting configuration, the fabric or mat can optionally be pre-treated and/or post-treated with one or more fire-retardant materials (e.g., halogenated compound containing coatings, expandable graphite containing coatings, etc.).

The fabric or mat generally has a different composition and/or configuration from the optional internal reinforcement used in layer of bitumen compound; however, this is not required.

### The Release Liner or Underside Material

A release liner can be optionally applied to the roofing membrane system to form a removable top and/or bottom layer of roofing membrane system. Such release liner can be formed of a paper (e.g. kraft paper, super calendared kraft paper, clay coated kraft paper, polymer coated kraft paper, glazed paper, etc.) or a polymeric film (e.g., PET film, polypropylene film, polyolefins film, polyethylene films, PP films, etc.) or a paper that is coated with a polymeric film. The thickness of the release liner is generally 0.2-50 mil (and all values and ranges therebetween). In one non-limiting configuration, the thickness of the release liner (when used) is 1-10 mil.

As can be appreciated, the bottom surface of the bitumen compound layer or the top and/or bottom surface of the roofing membrane can be absent a release liner. In one alternative non-limiting embodiment, the bottom surface of the bitumen compound layer or the bottom surface of the roofing membrane can include a material other than a release liner, such as a ground glass layer, a sand layer, and/or a fire-resistant layer on the bottom surface of the layer of bitumen compound or the bottom surface of the roofing membrane.

### Polymer Layer or Polymer Coating

A polymer layer (e.g., polymer sheet, polymer film, etc.) or a polymer coating can optionally be secured and/or applied to a top surface and/or to a bottom surface of the layer of bitumen compound. The composition of the polymer layer or the polymer coating is non-limiting. The thickness of the polymer layer or the polymer coating is non-limiting. The thickness of the polymer layer or the polymer coating (when used), is generally at least 0.1 mil and typically no more than 300 mil (and all values and ranges therebetween). The polymer layer can have one or more purposes such as, but not limited to, a) strengthen the roofing membrane, b) form a protective top layer for the roofing membrane, c) form a bleed blocker layer to inhibit or prevent oils, etc. in the bitumen compound layer from passing through the polymer coating layer, d) form a reflective top surface of the roofing membrane, and/or e) form a protective layer over the bitumen compound layer.

When the polymer layer is applied as a liquid coated layer, the polymer layer can be spray coated or roll coated on the underside surface and/or top surface of the bitumen compound layer, but it is not limited to these application methods. As can be appreciated, any application method available in the art can be used to deposit a liquid coating of the polymer layer.

The composition of the polymer layer (e.g., preformed polymer sheet, preformed polymer film, etc.) or the polymer coating can include one or more of acrylic coating, polyvinyl alcohol coating, nitrile rubber coating, thermoplastic urethane coating, polyamide coating, vinyl acetate coating, latex coating, SBR coating, SBS coating, SEBS coating, SIS coating, natural or synthetic rubber coating, low density polyethylene (LDPE) coating, linear low density polyethylene (LLDPE) coating, medium density polyethylene (MDPE) coating, high density polyethylene (HDPE) coating, cast unrented polypropylene (CPP) coating, biaxially oriented polypropylene (BOPP) coating, polyethylene/polyamide (PE/PA) coating, polyester coating, polyethylene terephthalate coating, polyurethane coating, polyamide coating, silicone coating, polyurethane coating, polyvinyl fluoride (PVF), poly (methyl methacrylate) coating, PVDF (polyvinyladine fluoride), TPO (thermoplastic olefin or thermoplastic polyolefin), EPDM (ethylene propylene diene monomer), PVC (polyvinyl chloride), CSPE (chlorosulfonated polyethylene), EPM (ethylene propylene monomer), KEE (ketone ethylene ester), polyurea, poly (methyl methacrylate), silicone or some combination of the above and/or or some other type of polymeric and/or elastomeric coating. The polymer layer or polymer coating can be applied to the roofing membrane after the roofing membrane has been installed on a building structure (e.g., roof of a building, etc.) or prior to the roofing material has been installed.

### Particle Layer

Granules can optionally form at least a portion or all of the top surface of the roofing membrane. Generally, the granules are inert granules. Many types of granules can be used (e.g., paint-coated granules, polymer-coated granules, metallic-coated granules, ceramic-coated granules, mineral-formed granules, slag, composite-formed granules, etc.).

In another non-limiting embodiment, the granules generally have a size of at least 200 microns (e.g., 200 microns to 6 mm and all values and ranges therebetween; 450 microns to 1 mm, etc.). As can be appreciated, the size of the granules is non-limiting.

### Graphene Layer

The roofing membrane can optionally include one or more layers of graphene, which one or more layers are separate from the bitumen compound layer. The graphene layer, when used, can be an extruded layer that is formed of graphene and polymer material; however, this is not required. The thickness of the graphene layer, when used, is non-limiting. When the graphene layer is used, the one or more graphene layers are generally partially or fully encapsulated within the layer of bitumen compound; however, this is not required. It can be appreciated that one or more of the graphene layers can also or alternatively be connected to the top and/or bottom surface of the bitumen compound layer by one or more connection mechanisms (e.g., adhesive connection, mechanical connection [e.g., stitching, staples, hook and loop connection, snaps, etc.], melted or other type of heat created and/or pressure created connection, etc.). In one non-limiting embodiment, when the graphene layer is a combination of graphene and polymer, the weight ratio of graphene to polymer in the graphene layer is 99.99:1 to 1:99.99 (and all values and ranges there between). In one non-limiting graphene layer formulation, the weight ratio of the polymer material to the graphene in the graphene layer is 99:1 to 51:1. The polymer used to form of the graphene layer can be or include one or more of APAO (Amorphous Polyolefin), APP (Atactic Polypropylene), EVA (Ethylene Vinyl Acetate), EBA (Ethylene Butyl Acrylate), PPA (Polyphthalamide), PPI (Polymeric Polyisocyanate), PE (Polyethylene), PP (Polypropylene), SEBS (Styrene Ethylene Butadiene Styrene), SBS (Styrene Butadiene Styrene), SIS (Styrene-Isoprene-Styrene), SBR (styrene-butadiene-rubber), thermoplastic urethane (TPU), etc. Generally, the thickness of each layer of graphene is at least 0.1 mil (e.g., 0.1-200 mils and all values and ranges therebetween).

### Method for Forming Bitumen Compound

During the formation of the bitumen compound, the primary hydrocarbon compound is generally heated to a temperature wherein the primary hydrocarbon compound obtains a liquid or molten state. After the primary hydrocarbon compound has obtained a liquid or molten state, and when graphene is to be mixed in the bitumen compound layer, the graphene or graphene mixture (e.g., graphene and process oil mixture, pellet form of graphene that includes graphene and polymer, etc.) is added to the liquid or molten primary hydrocarbon compound and mixed therein. The other components of the bitumen compound can be added prior to or after the primary hydrocarbon compound has obtained a liquid or molten state. When the fabric or mat is to be partially or fully encapsulated and/or saturated with the bitumen compound, the bitumen compound is in a liquid or molten state when the bitumen compound is applied (e.g., poured onto the fabric or mat, sprayed onto the fabric or mat, etc.) and/or the fabric or mat is partially or fully immersed in the bitumen compound while the bitumen compound is in the liquid or molten state.

It is one non-limiting object of the disclosure to provide a roofing membrane that has improved strength, a reduced about of heat release, and/or a reduced amount of smoke production.

It is another and/or alternative non-limiting object of the disclosure to provide a roofing membrane that includes graphene.

It is another and/or alternative non-limiting object of the disclosure to provide a roofing membrane that includes graphene, and wherein the roofing membrane has improved strength, a reduced about of heat release, and/or a reduced amount of smoke production.

It is another and/or alternative non-limiting object of the disclosure to provide a roofing membrane that includes graphene and a reinforcement fabric or mat.

It is another and/or alternative non-limiting object of the disclosure to provide a roofing membrane that includes graphene and a reinforcement fabric or mat that is partially or fully encapsulated and/or saturated in a layer of bitumen compound.

In another and/or alternative non-limiting object, there is provided a roofing membrane that includes at least two layers, namely 1) a layer of bitumen compound, and 2) a fabric or mat, and can optionally include a) an optional layer of graphene that is i) located between the layer of bitumen compound and the fabric or mat and/or ii) partially or fully encapsulated and/or saturated in a layer of bitumen compound, b) an optional polymer layer or coating that is applied to or above a top surface of the layer of bitumen compound, c) an optional release liner that is releasably positioned on the bottom surface of the roofing membrane, d) an optional layer of granules that is located on the top surface of the layer of bitumen compound or top surface of the optional polymer layer of coating, and/or e) and optional release liner that forms a releasable top layer of the roofing membrane.

In another and/or alternative non-limiting object, there is provided a roofing membrane that includes a layer of bitumen compound that comprises a primary hydrocarbon compound; and optionally one or more of a) filler, b) polymer modifier, c) hydrocarbon resin or process oil, d) tackifying agent, e) antioxidant, f) UV stabilizer, g) cross-linkers, h), adhesion enhancer, i) fire retardant, j) graphene, k) wax, l) charring agent, and/or m) reinforcement fibers.

In another and/or alternative non-limiting object, there is provided a roofing membrane that includes a layer of bitumen compound that is partially or fully formed of a rubber-modified bitumen and graphene.

In another and/or alternative non-limiting object, there is provided a roofing membrane that includes fire-retardant properties.

In another and/or alternative non-limiting object, there is provided a roofing membrane wherein the bottom surface of the roofing membrane includes a ground glass layer, a sand layer, or fire-resistant layer.

Other objects, advantages, and novel features of the present invention will become apparent from the following detailed description of the invention when considered in conjunction with the accompanying drawings.

### BRIEF DESCRIPTION OF THE DRAWINGS

The following is a brief description of the drawings, which are presented for the purposes of illustrating the exemplary objects disclosed herein and not for the purposes of limiting the same.

FIGS. 1-4 are various non-limiting examples of the roofing membrane in accordance with the present disclosure.

FIG. 5 is a graph that illustrates the rate of heat release from a roofing membrane that does and does not include graphene.

FIG. 6 is a graph that illustrates the rate of smoke production from a roofing membrane that does and does not include graphene.

FIG. 7 is a table that illustrates the tensile load strain of a roofing membrane that does and does not include graphene.

### DETAILED DESCRIPTION OF VARIOUS NON-EMBODIMENTS OF DISCLOSURE

A more complete understanding of the articles/devices, processes and components disclosed herein can be obtained by reference to the accompanying drawings. These figures are merely schematic representations based on convenience and the case of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments and are not intended to define or limit the scope of the disclosure. In the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 10% of the indicated number.

Percentages of elements should be assumed to be percent by weight of the stated element, unless expressly stated otherwise.

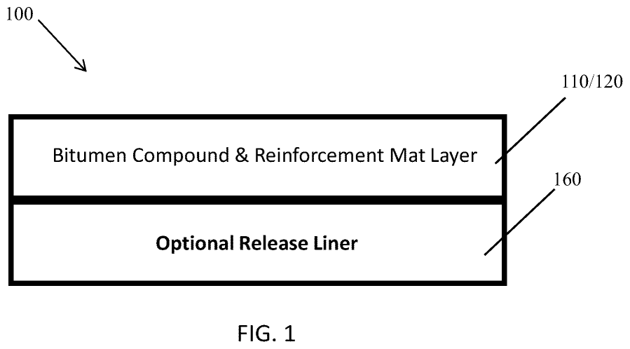

Referring now to the drawings which illustrate non-limiting embodiments of the roofing membrane in accordance with the present disclosure, FIGS. 1-3 illustrate various non-limiting features and/or properties of the roofing membrane in accordance with the present disclosure.

The a roofing membrane 100 includes at least two layers, namely 1) a layer of bitumen compound 110, and 2) a fabric or mat 120, and can optionally include a) an optional layer of graphene 130 that is i) located between the layer of bitumen compound 110 and the fabric or mat 120 and/or ii) partially or fully encapsulated and/or saturated in a layer of bitumen compound 110, b) an optional polymer layer 140 or coating that is applied to or above a top surface of the layer of bitumen compound 110, c) an optional release liner 160 that is releasably positioned on the bottom surface of the roofing membrane, d) an optional layer of granules 150 that is located on the top surface of the layer of bitumen compound 110 or top surface of the optional polymer layer 140 of coating, and/or e) an optional release liner 160 that forms a releasable top layer of the roofing membrane.

The roofing membrane 100 in accordance with the disclosure provides a user (e.g., contractor, etc.) with a ready-made roofing membrane.

The layer of bitumen compound 110 can include a rubber-modified bitumen containing SBS, SEBS, SIS, or other rubber polymers. Generally, the layer of bitumen compound includes a primary hydrocarbon compound and optionally contains one or more of a) filler, b) polymer modifier (e.g., SBS, SEBS, SIS, or other rubber polymers), c) hydrocarbon resin or process oil, d) tackifying agent, c) antioxidant, f) UV stabilizer, g) cross-linkers, h)) adhesion enhancer, i) fire retardant, j) graphene, k) wax, l) charring agent, and/or m) reinforcement fibers. In one non-limiting specific embodiment, the layer of bitumen compound include a primary hydrocarbon compound, filler, polymer modifier, and graphene and optionally one or more of a) hydrocarbon resin or process oil, b) tackifying agent, c) antioxidant, d) UV stabilizer, e) cross-linkers, h) adhesion enhancer, g) fire retardant, h) wax, i) charring agent, and/or j) reinforcement fibers. In another non-limiting specific embodiment, the layer of bitumen compound include a primary hydrocarbon compound, filler, polymer modifier, graphene, and fire retardant and optionally one or more of a) hydrocarbon resin or process oil, b) tackifying agent, c) antioxidant, d) UV stabilizer, c) cross-linkers, f) adhesion enhancer, h) wax, h) charring agent, and/or i) reinforcement fibers. In another non-limiting specific embodiment, the layer of bitumen compound include a primary hydrocarbon compound, filler, polymer modifier, graphene, fire retardant, hydrocarbon resin or process oil, wax, antioxidant, charring agent and UV stabilizer and optionally one or more of a) tackifying agent, b) cross-linkers, c) adhesion enhancer, and/or d) reinforcement fibers.

The layer of bitumen compound 110 optionally includes an internal fabric or mat 120 to add reinforcement and internal strength to the layer of bitumen compound. The fabric or mat 120 can be partially of fully encapsulated and/or saturated in the layer of bitumen compound 110. As can be appreciated, the fabric or mat 120 can be connected to the top or bottom surface of the layer of bitumen compound 110. As can be appreciated, more than one fabric or mat 110 can be used. In one non-limiting configuration, the fabric or mat 120 is positioned in the layer of bitumen compound 110 and is spaced from the top and/or bottom surface of the layer of bitumen compound 110. The fabric or mat 120 can be formed of a woven and/or non-woven material. The material that forms the fabric or mat 120 can include, but is not limited to, polyester, glass fibers, and/or a combination of polyester and glass fibers. The fabric or mat 120 can have a thickness of 5-20 mil.

The bottom surface of the roofing membrane 100 can optionally be formulated to be a self-adhering surface. When the bottom surface of the roofing membrane is formulated to be a self-adhering surface, the bottom surface of the roofing membrane 100 can optionally include a release liner 160. The release liner 160 can have a thickness of 1-10 mil, and which release liner 160 can be optionally treated with a polymer (e.g., silicone, etc.). As can be appreciated, a release liner 160 is not necessary with a roofing membrane 100 that is not self-adhering, such as a roofing membrane that as a bottom surface that includes ground glass, sand, a burn backer, etc. As can be appreciated, a release liner 160 can still be used even when the roofing membrane 100 is not self-adhering.

Non non-limiting formulations of the bitumen compound 110 that is included in the roofing membrane 100 includes:

### Example A

Primary hydrocarbon compound 35-65 wt. % (e.g., 80-100 wt. % bitumen or asphalt)
Filler (e.g., limestone, calcium carbonate, 10-35 wt. % silica, talc, etc.)
Polymer Modifier (e.g., SBS, Polyurethane, etc.) 6-18 wt. %
Hydrocarbon Resin Process Oil (e.g., naphthenic 0.4-5 wt. % oil, paraffinic oil, etc.)
Antioxidant 0.05-2 wt. %
UV Stabilizer 0.05-3 wt. %
Cross-Linker 0-4 wt. %
Adhesion Enhancer 0-1 wt. %
Fire Retardant 2-18 wt. %
Tackifying Agent (e.g., alumina trihydrate, 0-1 wt. % ammonium polyphosphate, etc.)
Wax (e.g., paraffin wax, polypropylene wax, etc.) 0.1-1.5 wt. %
Internal Reinforcement Fiber (e.g., fiber, etc.) 0-15 wt. %
Graphene 0.02-5 wt. %
Charring Agent 0.05-5 wt. %.

### Example B

Primary hydrocarbon compound 45-55 wt. % (e.g., 90-100 wt. % bitumen or asphalt)
Filler (e.g., limestone, calcium carbonate, 15-25 wt. % silica etc.)
Polymer Modifier (e.g., SBS, etc.) 7-14 wt. %
Hydrocarbon Resin Process Oil (e.g., naphthenic 0.6-1.6 wt. % oil, paraffinic oil, etc.)
Antioxidant 0.05-0.8 wt. %
UV Stabilizer 0.05-0.8 wt. %
Cross-Linker 0-2 wt. %
Adhesion Enhancer 0-1 wt. %
Fire Retardant 6-16 wt. %
Tackifying Agent (e.g., alumina trihydrate, 0-1 wt. % ammonium polyphosphate, etc.)
Wax (e.g., paraffin wax, polypropylene wax, etc.) 0.2-0.8 wt. %
Internal Reinforcement Fiber (e.g., fiber, etc.) 0-12 wt. %
Graphene 0.02-3 wt. %
Charring Agent 0.5-3 wt. %.

For Examples A & B, it will be appreciated that all of the above ranges include any value between the range and any other range that is between the ranges set forth above. Any of the above values that include the range from 0 to the stated value also includes and all values and ranges therebetween.

Referring now to FIGS. 1-4, several non-limiting embodiments of the roofing membrane 100 in accordance with the present disclosure are illustrated.

FIG. 1 illustrates a roofing membrane 100 formed of a layer of bitumen compound 110 and a fabric or mat layer 120 that is partially or fully encapsulated and/or saturated in a layer of bitumen compound 110, The bottom surface of the bitumen compound layer and fabric or mat layer 110/120 can optionally be a release liner 160.

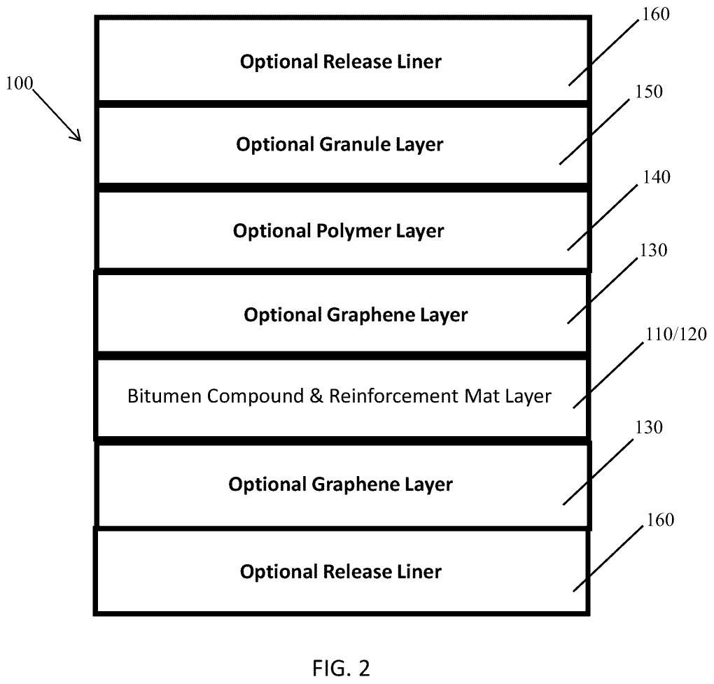

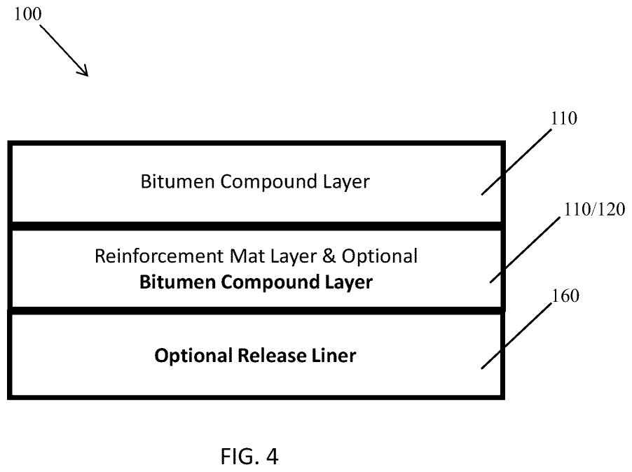

FIG. 2 illustrates a layer of bitumen compound 110 and a fabric or mat layer 120 that is partially or fully encapsulated and/or saturated in a layer of bitumen compound 110. The bottom surface of the bitumen compound layer and fabric or mat layer 110/120 can optionally be connected to a) a layer of graphene 130, or b) a release liner 160. If an optional layer of graphene 130 is used, the bottom surface of the graphene 130 can optionally include the release liner 160. If the optional layer of graphene 130 is not used, the bottom surface of the bitumen compound layer and fabric or mat layer 110/120 can optionally include the release liner 160. The top surface of the bitumen compound layer and fabric or mat layer 110/120 can optionally be connected to a) a layer of graphene or graphene and polymer 130, b) a layer of polymer 140, c) a layer of granules 150, or d) a release liner 160. Any combination of layers and order of layers of graphene or graphene and polymer 130, polymer 140, granules 150, and release liner 160 can be used. For example, the roofing membrane of FIG. 4 can only include a polymer layer 140 and a release liner 160 on and above the top surface of the bitumen compound layer and fabric or mat layer 110/120 wherein the polymer layer 140 is connected to the top surface of the bitumen compound layer and fabric or mat layer 110/120, and the release liner 160 is releasably connected to the top surface of the polymer layer 140. In another non-limiting example, one a granule layer 150 is connected to the top surface of the bitumen compound layer and fabric or mat layer 110/120. In another non-limiting example, only a polymer layer 140 and a granule layer 150 is on and above the top surface of the bitumen compound layer and fabric or mat layer 110/120, wherein the polymer layer 140 is connected to the top surface of the bitumen compound layer and fabric or mat layer 110/120, and the granule layer 150 is connected to the top surface of the polymer layer 140. In another non-limiting example, only graphene layer 143, a polymer layer 140 and a granule layer 150 is on and above the top surface of the bitumen compound layer and fabric or mat layer 110/120, wherein the a layer of graphene or graphene and polymer 130 is connected to the top surface of the bitumen compound layer and fabric or mat layer 110/120, the polymer layer 140 is connected to the top surface of the a layer of graphene or graphene and polymer 130, and the granule layer 150 is connected to the top surface of the polymer layer 140.

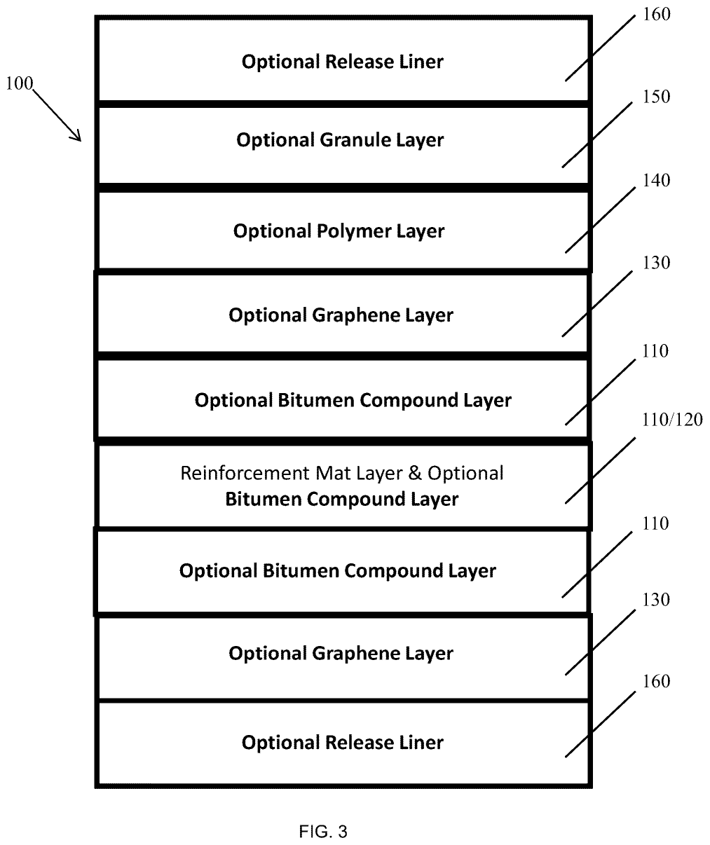

FIG. 3 illustrates a layer of fabric or mat layer 120 that is optionally partially or fully encapsulated and/or saturated in a layer of bitumen compound 110. The bottom surface of the fabric or mat layer 110/120 that is optionally partially or fully encapsulated and/or saturated in a layer of bitumen compound 110 can optionally be connected to a) a layer of bitumen compound 110, b) a layer of a layer of graphene or graphene and polymer 130, or c) a release liner 160. Any combination of layers and order of layers of bitumen compound 110, a layer of graphene or graphene and polymer 130, and release liner 160 can be used. The top surface of the fabric or mat layer 110/120 that is optionally partially or fully encapsulated and/or saturated in a layer of bitumen compound 110 can optionally be connected to a) a layer of bitumen compound 110, b) a layer of a layer of graphene or graphene and polymer 130, c) a layer of polymer 140, d) a layer of granules 150, or e) a release liner 160. Any combination of layers and order of layers of bitumen compound 110, a layer of graphene or graphene and polymer 130, polymer 140, granules 150, and release liner 160 can be used.

FIG. 4 illustrates a roofing membrane 100 formed of a layer of bitumen compound 110 that is positioned on a top surface of a layer of bitumen compound 110 and a fabric or mat layer 120 that is partially or fully encapsulated and/or saturated in a layer of bitumen compound 110. The bottom surface of the bitumen compound layer and fabric or mat layer 110/120 can optionally be a release liner 160. The thickness of the layer of bitumen compound 110 that is positioned on a top surface of a layer of bitumen compound 110 and a fabric or mat layer 120 can be the same thickness, a greater thickness or a lesser thickness than the layer of bitumen compound layer and fabric or mat layer 110/120. The layer of bitumen compound 110 that is positioned on a top surface of a layer of bitumen compound 110 and a fabric or mat layer 120 can be coated on the layer of bitumen compound layer and fabric or mat layer 110/120, or connected to the layer of bitumen compound layer and fabric or mat layer 110/120 by other or means. (e.g., adhesive connection, mechanical connection [e.g., stitching, staples, hook and loop connection, snaps, clamp, etc.], melted or other type of heat created and/or pressure created connection, etc.).

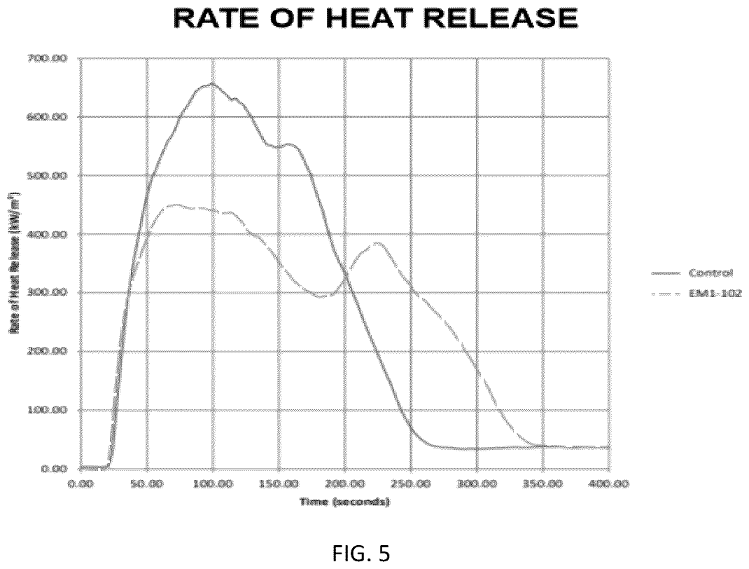

Referring now to FIGS. 5-7, there is illustrated a comparison between two roofing membranes that are formed of a layer of bitumen compound and a fabric or mat that is fully encapsulated in the layer of bitumen compound. The fabric or mats in both roofing membranes are the same as to size, composition, thickness, and the manner in which the fabric or mat is made. The layer of bitumen compound has the same composition except that the control formulation (Control) of the bitumen compound is absent graphene and the new formulation of the bitumen compound (EM1-102) in accordance with the present disclosure includes graphene.

FIG. 5 illustrates cone calorimeter data for the Control and EM1-102 roofing membrane. FIG. 5 illustrates that there is a 33% decrease in the rate of heat release from the EM1-102 roofing membrane as compared to the heat release from the Control roofing membrane. Such data is evidence that the EM1-102 roofing membrane is more fire resistant than the Control roofing membrane.

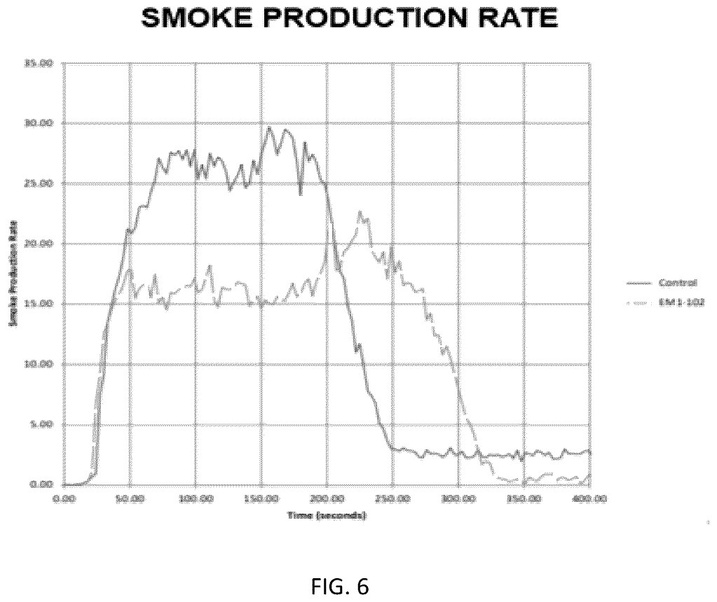

FIG. 6 illustrates additional cone calorimeter data for the Control and EM1-102 roofing membrane. FIG. 6 illustrates that there is a 33% decrease in the rate of smoke production rate from the EM1-102 roofing membrane as compared to the rate of smoke production rate from the Control roofing membrane. Such data is evidence that the EM1-102 roofing membrane generates less smoke.

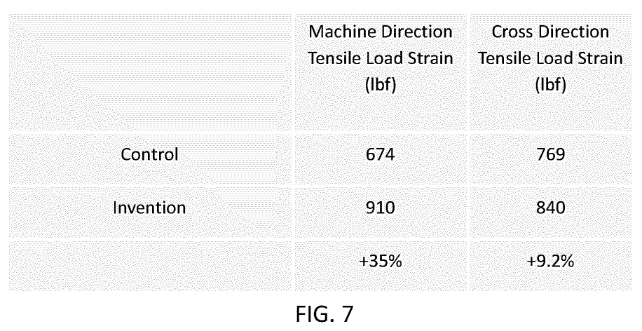

FIG. 7 is a table that illustrates the tensile load strain the Control and EM1-102 roofing membrane using testing per ASTM D5147. FIG. 7 illustrated that the EM1-102 roofing membrane has a net increase of 22% in tensile load strain as compared to the Control roofing membrane.

The description of embodiments and examples has been presented for purposes of illustration and description. It is not intended to be exhaustive or limiting to the forms described. Numerous modifications are possible in light of the teachings herein. Some of those modifications have been discussed, and others will be understood by those skilled in the art. The embodiments were chosen and described in order to illustrate principles of various embodiments as are suited to particular uses contemplated. The scope is, of course, not limited to the examples set forth herein, but can be employed in any number of applications and equivalent devices by those of ordinary skill in the art.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall there between. The invention has been described with reference to the preferred embodiments. These and other modifications of the preferred embodiments as well as other embodiments of the invention will be obvious from the disclosure herein, whereby the foregoing descriptive matter is to be interpreted merely as illustrative of the invention and not as a limitation. It is intended to include all such modifications and alterations insofar as they come within the scope of the appended claims.

To aid the Patent Office and any readers of this application and any resulting patent in interpreting the claims appended hereto, applicants do not intend any of the appended claims or claim elements to invoke 35 U.S.C. 112(f) unless the words “means for” or “step for” are explicitly used in the particular claim.

What is claimed:

1. A roofing membrane that includes a layer of bitumen compound, a fabric or mat, and graphene.

2. The roofing membrane as defined in claim 1, wherein said bitumen compound includes primary hydrocarbon compound and one or more of a) filler, b) polymer modifier, c) hydrocarbon resin or process oil, d) tackifying agent, e) antioxidant, f) UV stabilizer, g) cross-linkers, h) adhesion enhancer, i) fire retardant, j) wax, k) charring agent, l) said graphene and/or m) reinforcement fiber.

3. The roofing membrane as defined in claim 1, wherein said graphene is include included in said layer of bitumen compound.

4. The roofing membrane as defined in claim 1, wherein said graphene is added to said layer of bitumen compound when said bitumen compound is in a liquid or molten state; said graphene is added to said bitumen compound in the form of a) a mixture of graphene and process oil, b) powered or granular graphene, and/or c) an extrusion of graphene and polymer, and wherein a weight ratio of said graphene to polymer in said extrusion of graphene and polymer is 1:99.99 to 99.99:1.

5. The roofing membrane as defined in claim 1, wherein said fabric or mat is a) partially encapsulated by said layer of bitumen compound, b) fully encapsulated by said layer of bitumen compound, c) partially saturated by said layer of bitumen compound, d) fully saturated by said layer of bitumen compound, and/or e) secured to the top or bottom surface of said layer of bitumen compound.

6. The roofing membrane as defined in claim 1, wherein said layer of bitumen compound comprises by weight percent:
Primary hydrocarbon compound 0.1-90 wt. %
Filler 0-70 wt. %
Polymer Modifier 0-50 wt. %
Hydrocarbon Resin Process Oil 0-30 wt. %
Antioxidant 0-30 wt. %
UV Stabilizer 0-20 wt. %
Cross-Linker 0-30 wt. %
Adhesion Enhancer 0-30 wt. %
Fire Retardant 0-50 wt. %
Tackifying Agent 0-30 wt. %
Wax 0-15 wt. %
Internal Reinforcement Fiber 0-40 wt. %
Graphene 0-30 wt. %
Charring Agent 0-30 wt. %.

7. The roofing membrane as defined in claim 1, wherein said layer of bitumen compound comprises by weight percent:
Primary hydrocarbon compound 2-90 wt. %
Filler (e.g., calcium carbonate, silica, talc, etc.) 0.5-70 wt. %
Polymer Modifier (e.g., SBS, Polyurethane, etc.) 0.05-50 wt. %
Hydrocarbon Resin Process Oil (e.g., naphthenic 0-30 wt. % oil, paraffinic oil, etc.)
Antioxidant 0-30 wt. %
UV Stabilizer 0-20 wt. %
Cross-Linker 0-30 wt. %
Adhesion Enhancer 0-30 wt. %
Fire Retardant 0-30 wt. %
Tackifying Agent 0-30 wt. %
Wax 0-15 wt. %
Internal Reinforcement Fiber (e.g., fiber, etc.) 0-40 wt. %
Graphene 0.01-20 wt. %
Charring Agent 0-20 wt. %.

8. The roofing membrane as defined in claim 1, wherein said layer of bitumen compound comprises by weight percent:
Primary hydrocarbon compound 25-80 wt. %
Filler (e.g., calcium carbonate, silica, talc, etc.) 0.5-60 wt. %
Polymer Modifier (e.g., SBS, Polyurethane, etc.) 0.05-30 wt. %
Hydrocarbon Resin Process Oil (e.g., naphthenic 0-20 wt. % oil, paraffinic oil, etc.)
Antioxidant 0-5 wt. %
UV Stabilizer 0-5 wt. %
Cross-Linker 0-10 wt. %
Adhesion Enhancer 0-5 wt. %
Fire Retardant 0-25 wt. %
Tackifying Agent 0-5 wt. %
Wax 0-5 wt. %
Internal Reinforcement Fiber (e.g., fiber, etc.) 0-30 wt. %
Graphene 0.01-15 wt. %
Charring Agent 0-15 wt. %.

9. The roofing membrane as defined in claim 1, wherein said layer of bitumen compound comprises by weight percent:
Primary hydrocarbon compound 25-70 wt. %
Filler (e.g., calcium carbonate, silica, talc, etc.) 5-60 wt. %
Polymer Modifier (e.g., SBS, Polyurethane, etc.) 2-22 wt. %
Hydrocarbon Resin Process Oil (e.g., naphthenic 0-10 wt. % oil, paraffinic oil, etc.)
Antioxidant 0-1 wt. %
UV Stabilizer 0-1 wt. %
Cross-Linker 0-5 wt. %
Adhesion Enhancer 0-2 wt. %
Fire Retardant 0-20 wt. %
Tackifying Agent 0-2 wt. %
Wax 0-2 wt. %
Internal Reinforcement Fiber (e.g., fiber, etc.) 0-25 wt. % Graphene 0.02-10 wt. %
Charring Agent 0-10 wt. %.

10. The roofing membrane as defined in claim 1, wherein said layer of bitumen compound comprises by weight percent:
Primary hydrocarbon compound 30-60 wt. %
Filler (e.g., calcium carbonate, silica, talc, etc.) 5-40 wt. %
Polymer Modifier (e.g., SBS, Polyurethane, etc.) 5-20 wt. %
Hydrocarbon Resin Process Oil (e.g., naphthenic 0.2-5 wt. % oil, paraffinic oil, etc.)
Antioxidant 0.05-1 wt. %
UV Stabilizer 0.05-1 wt. %
Cross-Linker 0-5 wt. %
Adhesion Enhancer 0-2 wt. %
Fire Retardant 0.5-15 wt. %
Tackifying Agent 0-2 wt. %
Wax 0.1-2 wt. %
Internal Reinforcement Fiber (e.g., fiber, etc.) 0-20 wt. %
Graphene 0.02-6 wt. %
Charring Agent 0.05-6 wt. %.

11. The roofing membrane as defined in claim 1, wherein said layer of bitumen compound comprises by weight percent:
Primary hydrocarbon compound 35-55 wt. %
Filler (e.g., calcium carbonate, silica, talc, etc.) 15-35 wt. %
Polymer Modifier (e.g., SBS, Polyurethane, etc.) 6-15 wt. %
Hydrocarbon Resin Process Oil (e.g., naphthenic 0.4-5 wt. % oil, paraffinic oil, etc.)
Antioxidant 0.05-1 wt. %
UV Stabilizer 0.05-1 wt. %
Cross-Linker 0-5 wt. %
Adhesion Enhancer 0-2 wt. %
Fire Retardant 1-15 wt. %
Tackifying Agent 0-2 wt. %
Wax 0.1-1.5 wt. %
Internal Reinforcement Fiber (e.g., fiber, etc.) 0-15 wt. %
Graphene 0.02-5 wt. %
Charring Agent 0.05-5 wt. %.

12. The roofing membrane as defined in claim 1, wherein said layer of bitumen compound comprises by weight percent:
Primary hydrocarbon compound 40-55 wt. %
Filler (e.g., calcium carbonate, silica, talc, etc.) 15-30 wt. %
Polymer Modifier (e.g., SBS, Polyurethane, etc.) 8-15 wt. %
Hydrocarbon Resin Process Oil (e.g., naphthenic 0.6-4 wt. % oil, paraffinic oil, etc.)
Antioxidant 0.05-1 wt. %
UV Stabilizer 0.05-1 wt. %
Cross-Linker 0-4 wt. %
Adhesion Enhancer 0-1 wt. %
Fire Retardant 5-15 wt. %
Tackifying Agent 0-1 wt. %
Wax 0.2-1.2 wt. %
Internal Reinforcement Fiber (e.g., fiber, etc.) 0-10 wt. %
Graphene 0.02-4 wt. %
Charring Agent 0.05-4 wt. %.

13. The roofing membrane as defined in claim 1, wherein said layer of bitumen compound comprises by weight percent:
Primary hydrocarbon compound 35-65 wt. % (e.g., 80-100 wt. % bitumen or asphalt)
Filler (e.g., limestone, calcium carbonate, 10-35 wt. % silica, talc, etc.)
Polymer Modifier (e.g., SBS, Polyurethane, etc.) 6-18 wt. %
Hydrocarbon Resin Process Oil (e.g., naphthenic 0.4-5 wt. % oil, paraffinic oil, etc.)
Antioxidant 0.05-2 wt. %
UV Stabilizer 0.05-3 wt. %
Cross-Linker 0-4 wt. %
Adhesion Enhancer 0-1 wt. %
Fire Retardant 2-18 wt. %
Tackifying Agent (e.g., alumina trihydrate, 0-1 wt. % ammonium polyphosphate, etc.)
Wax (e.g., paraffin wax, polypropylene wax, etc.) 0.1-1.5 wt. %
Internal Reinforcement Fiber (e.g., fiber, etc.) 0-15 wt. %
Graphene 0.02-5 wt. %
Charring Agent 0.05-5 wt. %.

14. The roofing membrane as defined in claim 1, wherein said layer of bitumen compound comprises by weight percent:
Primary hydrocarbon compound 45-55 wt. % (e.g., 90-100 wt. % bitumen or asphalt)
Filler (e.g., limestone, calcium carbonate, 15-25 wt. % silica etc.)
Polymer Modifier (e.g., SBS, etc.) 7-14 wt. %
Hydrocarbon Resin Process Oil (e.g., naphthenic 0.6-1.6 wt. % oil, paraffinic oil, etc.)
Antioxidant 0.05-0.8 wt. %
UV Stabilizer 0.05-0.8 wt. %
Cross-Linker 0-2 wt. %
Adhesion Enhancer 0-1 wt. %
Fire Retardant 6-16 wt. %
Tackifying Agent (e.g., alumina trihydrate, 0-1 wt. % ammonium polyphosphate, etc.)
Wax (e.g., paraffin wax, polypropylene wax, etc.) 0.2-0.8 wt. %
Internal Reinforcement Fiber (e.g., fiber, etc.) 0-12 wt. %
Graphene 0.02-3 wt. %
Charring Agent 0.5-3 wt. %.

15. The roofing membrane as defined in claim 1, wherein said fabric or mat is 2-400 mil in thickness.

16. The roofing membrane as defined in claim 1, wherein said fabric or mat is a woven mat and/or a non-woven mat.

17. The roofing membrane as defined in claim 1, wherein said roofing membrane has a) a decreased rate of heat release of at least 5% as compared to a similarly formulated and composed roofing membrane that is absent graphene, b) a decreased rate of smoke production of at least 5% as compared to a similarly formulated and composed roofing membrane that is absent graphene, c) an increase machine direction tension load strain of at least 5% as compared to a similarly formulated and composed roofing membrane that is absent graphene, and/or d) an increase cross direction tension load strain of at least 2% as compared to a similarly formulated and composed roofing membrane that is absent graphene.

18. The roofing membrane as defined in claim 1, wherein said primary hydrocarbon compound includes one or more of asphalt, bitumen, modified bitumen, coal-tar, coal-based alternatives (COPHALT), modified coal-tar, biosourced lignin-based asphalt alternatives, and/or asphalt/lignin-based blends.

19. The roofing membrane as defined in claim 1, wherein said polymer modifier includes one or more of APAO, APP, EVA, PPA, PPI, SEBS, SBS, SIS, polyurethane resins, polyurethane prepolymers, thermoplastic polyurethanes (TPUs), and blends thereof.

20. The roofing membrane as defined in claim 1, wherein said graphene has an average particle size of 0.1-100 microns.

21. The roofing membrane as defined in claim 1, further including granules on a top surface of said roofing membrane.

22. A method of forming a roofing membrane comprising:
a. providing a reinforcement layer;
b. providing a bitumen compound; said bitumen compound includes primary hydrocarbon compound and one or more of i) filler, ii) polymer modifier, iii) hydrocarbon resin or process oil, iv) tackifying agent, v) antioxidant, vi) UV stabilizer, vii) cross-linkers, viii) adhesion enhancer, ix) fire retardant, x) wax, xi) charring agent, xii) said graphene and/or xiii) reinforcement fiber; and
c. partially or fully coating, saturating, and/or encapsulating said reinforcement layer with said bitumen compound; and
wherein said roofing membrane includes graphene.

23. The method as defined in claim 22, wherein said bitumen compound includes said graphene; said graphene is added to said bitumen compound by A) adding particles of graphene to said bitumen compound while said bitumen compound is in liquid form and thereafter mixing said graphene in said bitumen compound while in said bitumen compound is in said liquid form, B) adding a solution of process oil and particles of graphene to said bitumen compound while said bitumen compound is in liquid form and thereafter mixing said graphene and process oil in said bitumen compound while in said bitumen compound is in said liquid form, and/or C) adding pellets of graphene and polymer material to said bitumen compound while said bitumen compound is in liquid form and thereafter mixing said pellets in said bitumen compound while in said bitumen compound is in said liquid form until said pellets melt and are mixed in said bitumen compound.

24. The method as defined in claim 22, further including the step of applying one or more layers of material on, above or below said reinforcement layer and/or said bitumen compound layer; said one or more layers selected from the group consisting of I) an additional layer of bitumen compound, II) a layer of graphene, III) a layer of graphene and polymer, IV) a polymer layer, V) a granule layer, and VI) a release liner.
